(19) United States
(12) Patent Application Publication
(10) Pub. No.: US 2002/0184387 A1
(43) Pub. Date: Dec. 5, 2002

(54) Method for connecting between networks, virtual router, and system for connecting between networks by using this virtual router

(75) Inventors: Arifumi Yamaya, Tokyo (JP); Shoji Fukutomi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/155,139

(22) Filed: May 28, 2002

(30) Foreign Application Priority Data
May 31, 2001 (JP) 2001-165065
Dec. 10, 2001 (JP) 2001-376361

(51) Int. Cl. G06F 15/173; H04L 12/28; H04L 12/56

(52) U.S. Cl. 709/238; 709/223; 370/400

(57) ABSTRACT

A plurality of routers are connected within the same network and are set in a relationship of a master and a backup according to the mounted VRRP, thereby to build up a virtual router. The virtual router transmits a packet that is input from the network or an external network, to a destination network. Substitute ports are provided in both routers, and these substitute ports are connected to each other. When a trouble has occurred on the route, a router in the backup state is changed to a master state, and a packet from a PC or the Internet is forwarded on the route via the substitute ports.

### FIELD OF THE INVENTION

This invention relates to a method for connecting between networks, a virtual router, and a system for connecting between networks by using this virtual router.

### BACKGROUND OF THE INVENTION

The VRRP is a protocol that has been prepared to assist a host unit which operates based on only the setting of a default route by a default router. The VRRP combines a plurality of apparatuses that connect between networks (routers) that are installed on the same network, thereby to realize a dispersion of the load of the routers and a backup function. In other words, the VRRP can recognize a plurality of grouped routers as one virtual router from a node (for example, a host unit or other router) that is installed on the network.

A master router (a virtual router) and a backup router are determined in advance to each group of routers, based on a priority set by the interface or based on whether a router is an IP address owner or not. An IP address is set to each VRID (virtual router identifier), and only the master router of a corresponding VRID actually carries out a packet forwarding processing by using the IP address. This IP address is an IP address as the virtual router separate from an IP address that is set to the router itself.

The master router notifies to the backup router that the master router is operating normally, by periodically sending an advertisement packet to the LAN. Based on the reception of this advertisement packet, the backup router confirms that the master router is operating. The backup router maintains a standby state during a period while it is confirmed that the master router is normally operating. When the backup router has not been able to receive the advertisement packet during a constant period of time, the backup router decides that an abnormal condition has occurred on the master router or the line and a trouble has occurred on the route. Then, the backup router carries out a packet forwarding processing on behalf of the master router.

FIG. 21 is a configuration diagram which shows a concept of a conventional system of a virtual router using the VRRP. In FIG. 21, a router 10 has two physical ports 10a and 10b for line connection that are provided on the interface not shown. The physical port 10a is connected to a PC1 as a host unit via a line A, and the physical port 10b is connected to the Internet 2 via a line C. A router 11 also has two physical ports 11a and 11b for line connection that are provided on the interface not shown. The physical port 11a is connected to the PC1 via a line B, and the physical port 11b is connected to the Internet 2 via a line D. The router 10 is set as a master router, and the router 11 is set as a backup router in advance, based on the above standard.

The router 10 carries out a forwarding of communication data as a virtual router Z to which an IP address has been set. Further, the router 10 periodically sends an advertisement packet to the set interface. Based on this, the backup router 11 knows that the router 10 itself is operating normally. With the above arrangement, the PC1 can transmit communication data to the virtual router Z by assigning the IP address, without being conscious about the two routers 10 and 11.

When the line A has been disconnected, for example, the advertisement packet does not reach the physical port 11a of the router 11. Therefore, the router 11 functions as the virtual router Z, and carries out the communication data forwarding operation. Consequently, the communication data transmitted from the PC1 is input to the router 11 via the line B. Thus, it becomes possible to forward the communication data from the physical port 11b to the Internet 2 via the line D.

According to the conventional example, however, when the line D has been disconnected, in addition to the disconnection of the line A, the router 11 cannot carry out the forwarding operation. Therefore, the router 11 cannot function as the virtual router Z. Consequently, it becomes impossible to make access from the PC1 to the Internet 2. As explained above, according to the conventional example, there has been a problem that it is not possible to carry out a data forwarding when any one of lines connected to the routers has been disconnected among the lines connected to all routers that constitute the virtual router Z.

### SUMMARY OF THE INVENTION

It is an object of this invention to provide a method for connecting between networks, a virtual router, and a system for connecting between networks by using this virtual router that make it possible to carry out a data forwarding even if a plurality of lines have been disconnected due to the occurrence of a trouble on a route among the lines connected to a virtual router.

According to one aspect of the present invention, there is provided method for connecting between networks, wherein a plurality of routers connected within the same network are set in a relationship of a master and a backup according to the mounted VRRP, thereby to build up a virtual router, the virtual router transmitting a packet input from the network or an external network to a destination network, and each router has at least one substitute port of an interface, connects the own substitute port to substitute ports of other routers with each other, and transfers the packet by using the substitute ports when a trouble has occurred on the route.

According to the above aspect of this invention, interface substitute ports are provided on a plurality of routers that constitute a virtual router. These substitute ports are connected with signal lines. When a trouble has occurred on the route, that is, when a transmission path has been disconnected, for example, a backup state is changed to a master state. Further, a packet is transferred on the route via these substitute ports. Therefore, even when one transmission path of each router has been disconnected, it is possible to overcome the difficult situation.

According to another aspect of the present invention, there is provided a virtual router which is constructed of a plurality of routers that are connected within the same network and are set in a relationship of a master and a backup by using the VRRP, and which transfers an input packet, wherein each router comprises: at least one substitute port of an interface, a connecting unit which connects between the substitute ports of the own router and the other routers, a state changeover unit which changes over the state of the router from a backup state to a master state according to a trouble on the route, and a transfer unit which transfers the packet by using the substitute port when a trouble has occurred on the route.

According to the above aspect of this invention, when a trouble has occurred on the route, that is, when a transmission path has been disconnected, for example, a state changeover unit changes over the state of a router from a backup state to a master state according to this trouble. The transfer unit transfers a packet using the substitute port. Therefore, even when one transmission path of each router has been disconnected, it is possible to overcome the difficult situation.

According to still another aspect of this invention, there is provided a virtual router which is constructed of a plurality of routers that are connected within the same network and are set in a relationship of a master and a backup using the VRRP. In this virtual router, each router comprises: an interface that is provided with an identification address and is set to a master state or a backup state, and that transmits a packet via a physical port, at least one substitute port in the interface, a connecting unit which connects between substitute ports of the own router and the other routers respectively, a state changeover unit which changes over the state of the interface from a backup state to a master state according to a trouble on the route, and a transfer unit which transfers the packet by using the substitute port when a trouble has occurred on the route.

According to the above aspect of the invention, when a trouble has occurred on the route, that is, when a transmission path has been disconnected, for example, a state changeover unit changes over the state of the interface from a backup state to a master state according to this trouble. The transfer unit transfers a packet by using the substitute port. Therefore, even when one transmission path of each router has been disconnected, it is possible to overcome the difficult situation.

According to still another aspect of this invention, there is provided a virtual router which is constructed of a plurality of routers that are connected within the same network and are set in a relationship of a master and a backup using the VRRP. In this virtual router, each router comprises: a plurality of interfaces each of which is provided with an identification address and is set to a master state or a backup state, and which transmits a packet via a physical port, at least one substitute port that is allocated as a substitute port that substitutes the plurality of interfaces and that is set such that theoretically mutually different substitute ports exist in the interfaces, a connecting unit which connects between substitute ports of the own router and the other router respectively, a state changeover unit which changes over the state of the interface from a backup state to a master state according to a trouble on the route, and a transfer unit which transfers the packet by using the substitute port when a trouble has occurred on the route.

According to the above aspect of the invention, one physical port is allocated as a substitute port that substitutes the plurality of interfaces and that is set such that theoretically mutually different substitute ports exist in the interfaces. When a trouble has occurred on the route, that is, when a transmission path has been disconnected, for example, the transfer unit transfers a packet by using the substitute port. Therefore, even when one transmission path of each router has been disconnected, it is possible to overcome the situation, by efficiently using the physical port.

According to still another aspect of this invention, there is provided a virtual router which is constructed of a plurality of routers that are connected within the same network and are set in a relationship of a master and a backup using the VRRP. In this virtual router, each router comprises: a plurality of interfaces each of which is provided with an identification address and is set to a master state or a backup state, and which transmits a packet via a physical port, physical ports that are normally used as ports of the interfaces, that are allocated as a physical port and a substitute port normally used in at least two interfaces, and that are set such that theoretically mutually different physical ports and substitute ports exist in the interfaces, a state changeover unit which changes over the state of the interface from a backup state to a master state according to a trouble on the route, and a transfer unit which transfers the packet by using the substitute port when a trouble has occurred on the route.

According to the above aspect of the invention, for example, two physical ports that are normally used are allocated as a physical port and a substitute port in the plurality of interfaces, and the physical ports are set such that theoretically mutually different physical ports and substitute ports exist in the interfaces. When a trouble has occurred on the route, that is, when a transmission path has been disconnected, for example, the transfer unit transfers a packet by using the substitute port. Therefore, even when one transmission path of each router has been disconnected, it is possible to overcome the situation, by efficiently using the physical port.

According to still another aspect of this invention, there is provided a system for connecting between networks. This system comprises: a virtual router which is constructed of a plurality of routers that are connected within the same network and are set in a relationship of a master and a backup using the VRRP, a node that transmits a packet to the routers based on one set address, and transmission paths that connect between the routers. In this system, the virtual router is constructed of the virtual router according to any one of the above aspects, and transmits a packet via the substitute ports according to a trouble on the route.

According to the above aspect of the invention, the virtual router according to any one of the above aspects is provided in which the substitute ports of the routers are connected to each other. When a trouble has occurred on the route, that is, when a transmission path has been disconnected, for example, a packet is transferred via the substitute port. Therefore, even when one transmission path of each router has been disconnected, it is possible to overcome the difficult situation.

Other objects and features of this invention will become understood from the following description with reference to the accompanying drawings.

### BRIEF DESCRIPTION OF THE DRAWINGS

FIG. 1 is a configuration diagram which shows a structure of a system of a virtual router using the VRRP according to a first embodiment of this invention,

FIG. 2 is a block diagram which shows a structure of the routers shown in FIG. 1,

FIG. 3 is a block diagram which shows a structure of a MAC frame processing section shown in FIG. 2,

FIG. 4 is a block diagram which shows a structure of a VRRP processing section shown in FIG. 2,

FIG. 5 is a flowchart which explains the operation of a packet reception by the router shown in FIG. 1,

FIG. 6 is a flowchart which explains the operation of a packet reception by the router shown in FIG. 1,

FIG. 7 is a flowchart which explains the operation of a packet reception by the router shown in FIG. 1,

FIG. 8 is a flowchart which explains the operation that the router shown in FIG. 1 changes from a backup state to a master state,

FIG. 9 is a flowchart which explains the operation of the router shown in FIG. 1 in the master state,

FIG. 10 is a configuration diagram which shows a structure of a system of a virtual router using the VRRP according to a second embodiment of this invention,

FIG. 11 is a configuration diagram which shows a structure of a system of a virtual router using the VRRP according to a third embodiment of this invention,

FIG. 12 is a configuration diagram which shows one example of a packet used in the third embodiment shown in FIG. 11,

FIG. 13 is a configuration diagram which shows a structure of a system of a virtual router using the VRRP according to a fourth embodiment of this invention,

FIG. 14 is a concept diagram which shows one example of a physical connection of the system shown in FIG. 13,

FIG. 15 is a configuration diagram which shows a structure of a system of a virtual router using the VRRP according to a sixth embodiment of this invention,

FIG. 16 is a block diagram which shows a structure of a MAC frame processing section shown in FIG. 15,

FIG. 17 is a flowchart which explains the operation of changing the state of the router shown in FIG. 15 from a backup state to a master state,

FIG. 18 is a flowchart which explains the operation that the router in the master state clears an entry of a learning table,

FIG. 19 is a flowchart which explains a packet transfer operation of the router in the master state after the entry of a learning table has been cleared,

FIG. 20 is a configuration diagram which shows a structure of a system of a virtual router using the VRRP according to a seventh embodiment of this invention, and

FIG. 21 is a configuration diagram which shows a concept of a conventional system structure of a virtual router using the VRRP.

### DETAILED DESCRIPTIONS

Preferred embodiments of a method for connecting between networks, a virtual router, and a system for connecting between networks by using this virtual router will be explained with reference to the attached drawings.

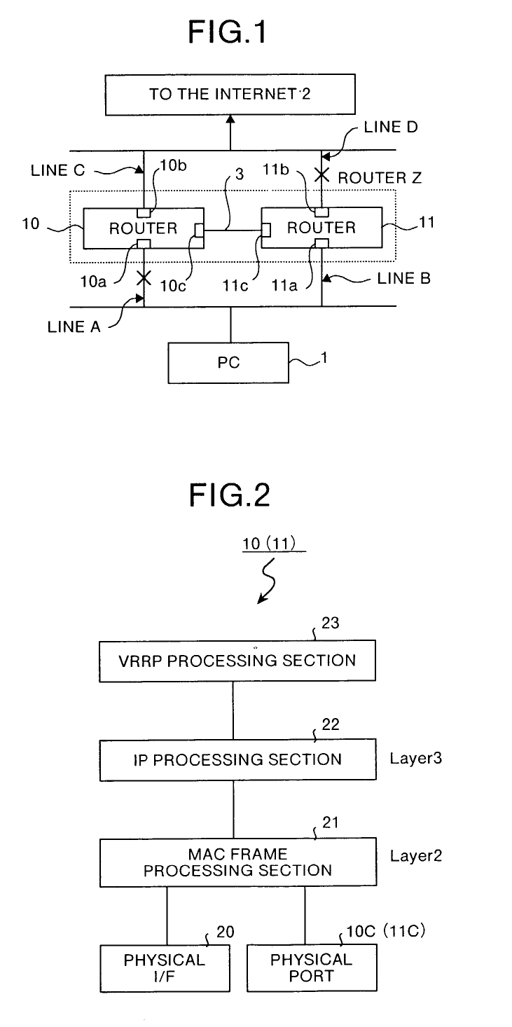

FIG. 1 is a configuration diagram which shows a structure of a system of a virtual router using the VRRP according to a first embodiment of this invention. Referring to FIG. 1, routers 10 and 11 that are identical to those shown in FIG. 21 have substitute ports (hereinafter to be referred to as “physical ports”) 10c and 11c respectively, in addition to line-connection physical ports 10a, 10b, 11a and 11b. These substitute ports 10c and 11c are connected to each other via a signal line 3. In the higher layer of these physical ports, there exist logical ports that are interfaces having IP addresses not shown. Physical ports that substitute these logical ports are substitute ports identical to the above substitute ports.

In this embodiment, the substitute ports of logical ports having the physical ports 10a and 11a are the substitute ports 10c and 11c. In the logical ports of the higher layer, a master state and a backup state of the VRRP are set to each logical port. The master logical port and the backup logical port are determined based on a pre-set priority and also based on whether the logical port is an IP address owner or not, as described above. The logical ports depend on the states of the logical ports in the higher layer of these ports. Other structures are similar to those of the system of a virtual router shown in FIG. 21. In the following explanation, identical constituent elements will be attached with like reference numbers.

The routers 10 and 11 have the same structures. FIG. 2 shows one example of this structure in a block diagram. In FIG. 2, the routers 10 and 11 are constructed of: a physical interface (hereinafter to be referred to as a “physical I/F”) 20 that is connected to the line-connection physical ports 10a and 10b (11a and 11b), an MAC frame processing section 21 in layer 2 to which the substitute ports 10c (11c) and the physical I/F 20 are connected, and an IP processing section 22 in a higher layer 3, and a VRRP processing section 23.

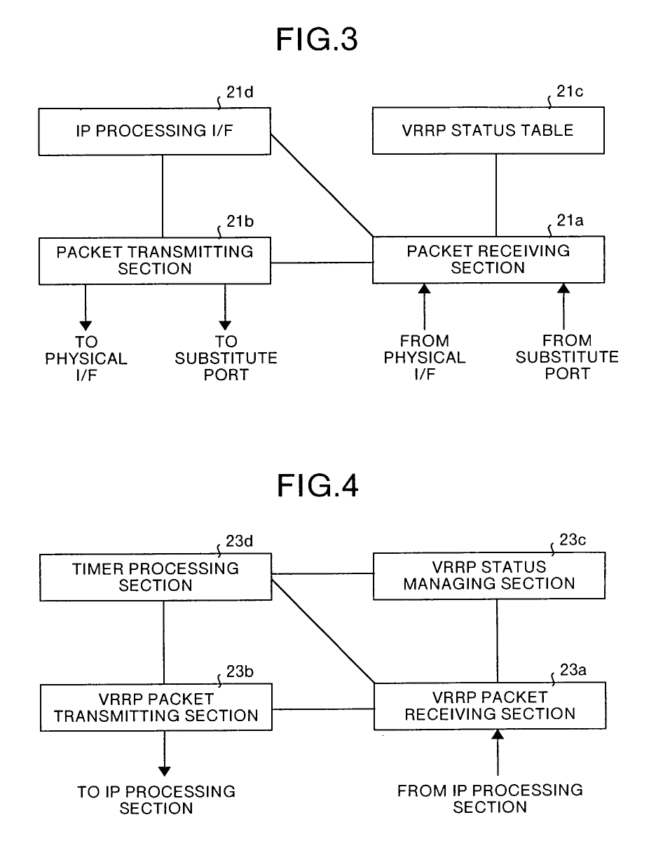

As shown in FIG. 3, the MAC frame processing section 21 is constructed of: a packet receiving section 21a that receives a packet from the substitute port 10c (11c) or the physical I/F 20, a packet transmitting section 21b that transmits a packet to the substitute port 10c (11c) or the physical I/F 20, a VRRP state table 21c that stores data in the VRRP state, and an IP processing I/F 21d that inputs/outputs a packet to/from the IP processing section 22. The VRRP state table 21c stores data that shows a master state or a backup state of each logical port, and data that shows a priority, for example.

As shown in FIG. 4, the VRRP processing section 23 is constructed of: a VRRP packet receiving section 23a that receives a packet from the IP processing section 22, a VRRP packet transmitting section 23b that transmits a packet to the IP processing section 22, a VRRP state managing section 23c that manages a VRRP state, and a timer processing section 23d that carries out a count processing of an advertisement timer and a master down timer at every predetermined period of time. The VRRP state managing section 23c manages whether each logical port or the own router is in the master state or the backup state, and manages the count state of the advertisement timer and the master down timer of the timer processing section 23d.

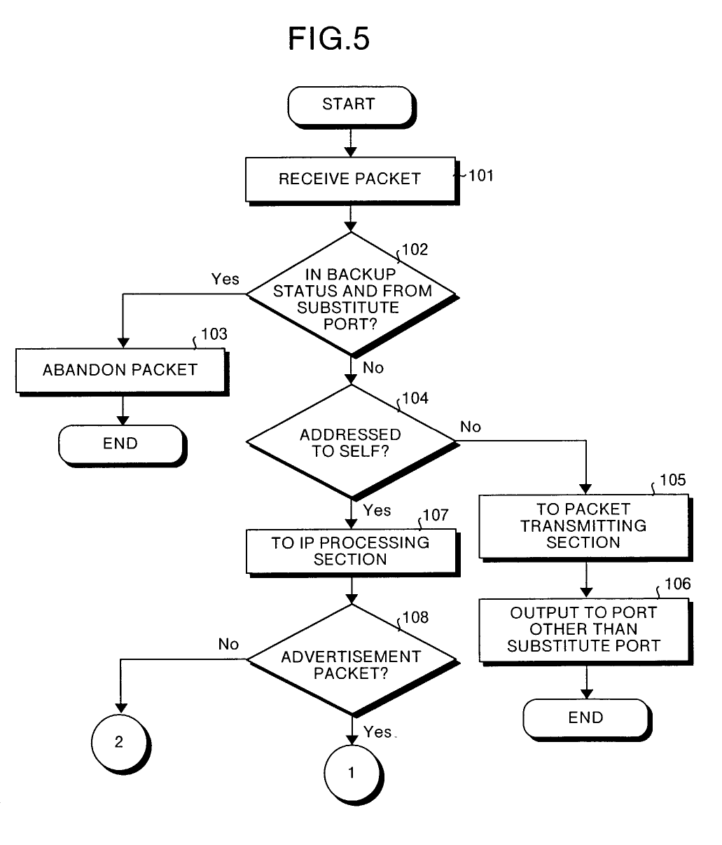

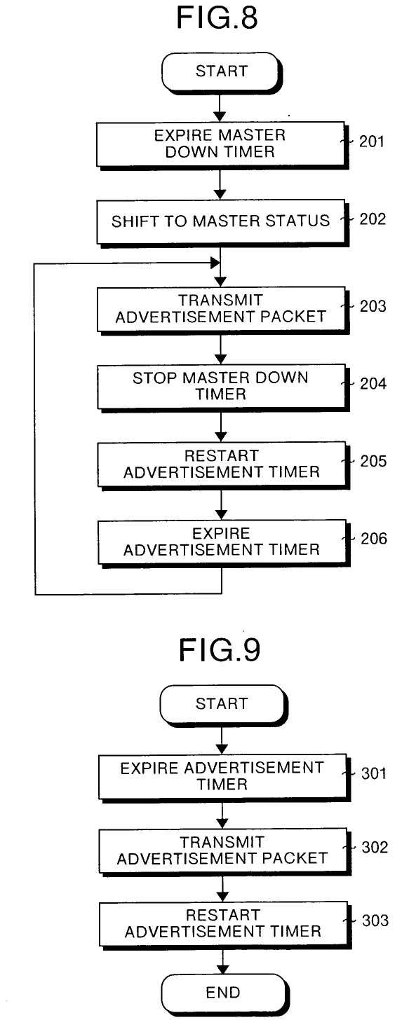

The operation of the routers in the above structure will be explained based on flowcharts shown in FIG. 5 to FIG. 9. The operation of the routers includes operations in mainly three events, that is, a packet reception, a backup state, and a master state. The packet reception operation of this embodiment will be explained with reference to FIG. 5 to FIG. 7. The transition operation from a backup state to a master state will be explained with reference to FIG. 8. The operation of a router in a master state will be explained with reference to FIG. 9.

The setting of a master router and a backup router to the routers 10 and 11 is determined in advance based on the standard of a priority and an IP address owner, as described above. In this example, it is assumed that the router 10 is in a master state, and the router 11 is a backup state based on the above standard. It is also assumed that the master router stops the master down timer and starts the advertisement timer of the timer processing section 23d respectively. Further, it is assumed that the backup router stops the advertisement timer and starts the master down timer of the timer processing section 23d respectively.

Referring to FIG. 5, the packet receiving section 21a of the MAC frame processing section 21 receives a packet (step 101). Then, the packet receiving section 21a decides whether the packet has been input from a router in the backup state and from the substitute port or not, by referring to the VRRP state table 21c (step 102).

When the packet has been received from a router in the backup state and from the substitute port, this packet is discarded, and the operation is finished (step 103). When the packet received from a router is not in the backup state or not from the substitute port, the packet receiving section 21a decides whether the packet has been addressed to the self or not, by referring to the MAC address that is a packet destination address (step 104).

When the packet has not been addressed to the self, the packet receiving section 21a outputs this packet to the packet transmitting section 21b (step 105). The packet transmitting section 21b carries out a forwarding processing in the layer 2 level, and outputs the packet from a physical I/F other than the substitute port to the physical port (step 106). When the packet has been addressed to the self, the packet receiving section 21a outputs this packet to the IP processing section 22 via the IP processing I/F 21d (step 107). The IP processing section 22 decides whether the packet is the advertisement packet or not from the type of the packet (step 108).

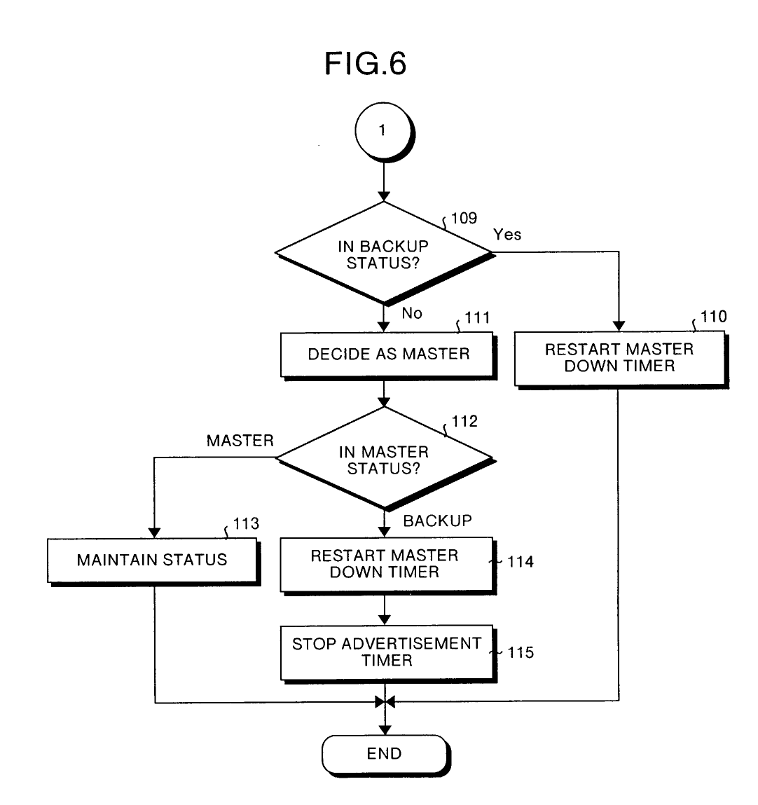

When the packet is the advertisement packet, the process proceeds to steps shown in FIG. 6, and it is decided whether the router is currently in the backup state or not (step 109). When the router is in the backup state, the VRRP packet receiving section 23a restarts the master down timer (step 110). When this router is not in the backup state, the VRRP packet receiving section 23a decides that the router is the master router (step 111). Next, the VRRP packet receiving section 23a decides whether the master state is to be unchanged or not (step 112). This decision is made based on the IP address of the transmitter from which the advertisement packet has been received, the priority, the own IP address, and based on whether a preempt mode is ON or not. The preempt mode shows whether a router of a low priority can become in a master state or not later. When the preempt mode is ON, this shows that this router can be in a master state later.

When the master state is to be unchanged, this state is maintained (step 113). When the router has become in the backup state instead of the master state, the VRRP packet receiving section 23a restarts the master down timer (step 114), and stops the advertisement timer (step 115).

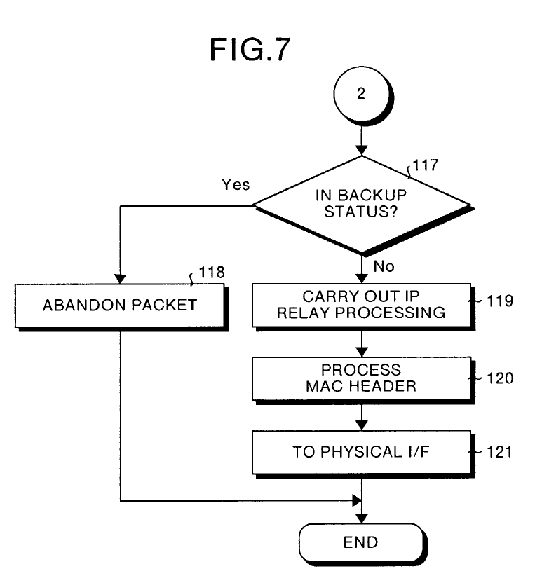

When the received packet is not the advertisement packet at step 108, the process proceeds to steps shown in FIG. 7, and it is decided whether the router is currently in the backup state or not (step 117). When the router is in the backup state, the received packet is discarded (step 118). When this router is not in the backup state, the IP processing section 22 carries out the IP forwarding processing in the layer 3 level (step 119). Then, the packet is output to the packet transmitting section 21b of the MAC frame processing section. The packet transmitting section 21b processes the MAC header (step 120), and transmits the packet to the physical I/F (step 121). Then, the physical I/F can transmit the packet to the line via the physical port.

The operation that the router changes from a backup state to a master state will be explained with reference to a flowchart shown in FIG. 8. In FIG. 8, the VRRP packet transmitting section 23b and the VRRP state managing section 23c are monitoring the master down timer of the timer processing section 23d.

When the counting of the master down timer has expired (step 201), the VRRP state managing section 23c decides that a trouble has occurred on the other router or the line has been disconnected, and changes the router to a master state (step 202). The VRRP packet transmitting section 23b prepares an advertisement packet, and transmits this advertisement packet to the physical I/F via the IP processing section 22 and the MAC frame processing section 21. The physical I/F further transmits this advertisement packet to the physical port (step 203).

The IP processing section 22 and the MAC frame processing section 21 output the advertisement packet after carrying out the respective header processing.

The VRRP packet transmitting section 23b controls the timer processing section 23d to stop the master down timer (step 204) and restart the advertisement timer (step 205). When the counting has expired after a lapse of a predetermined period of time since the advertisement timer restarted (step 206), the process returns to step 203 again, and the advertisement packet is transmitted.

With the above operation, the advertisement packet is transmitted to the other router from the physical port via the line. In principle, the advertisement packet is not transmitted from the substitute port.

The operation of the router in the master state will be explained with reference to a flowchart shown in FIG. 9. In FIG. 9, the VRRP packet, transmitting section 23b is monitoring the advertisement timer of the timer processing section 23d, as described above.

When the counting of the advertisement timer has expired (step 301), the VRRP packet transmitting section 23b prepares the advertisement packet, and transmits this advertisement packet to the physical I/F via the IP processing section 22 and the MAC frame processing section 21 (step 302). With this operation, the physical I/F can transmit this advertisement packet to the line via the physical port. Next, the VRRP packet transmitting section 23b restarts the advertisement timer (step 303), and waits for the expiration of the counting.

In the system of a virtual router according to this embodiment, when lines A and D have been disconnected, the router 10 transmits the advertisement packet from the physical port 10a to the line A. However, the advertisement packet does not reach the router 11, because of the disconnection of the line A.

Therefore, the counting of the master down timer of the router 11 expires, and the VRRP state managing section 23c of the router 11 decides that either a trouble has occurred on the router 10 or the line A has been disconnected. As the packet reaches the router 11 from the PC1 via the line B, the router 11 can confirm that the line B is normal. Then, the VRRP state managing section 23c changes the state of the router from the backup state to the master state.

The router 10 transmits the advertisement packet from the physical port 10b to the line C. However, the advertisement packet does not reach the router 11, because of the disconnection of the line D. Therefore, the counting of the master down timer of the router 11 expires, and the VRRP state managing section 23c of the router 11 decides that either a trouble has occurred on the router 10 or the line C or D has been disconnected.

As explained above, according to this embodiment, when the lines A and D have been disconnected, both the routers 10 and 11 becomes in the master state. The packet from the PC1 is input from the physical port 11a of the router 11 to the logical port. The packet is forwarded by the MAC frame processing section 21 and the IP processing section 22 (refer to FIG. 2), and is then output to the signal line 3 via the substitute port 11c.

The packet from the signal line 3 is taken into the router 10. Under the switching repeater operation, the packet passes through the substitute port 10c, the logical port and the physical port 10b, and is transmitted to the Internet 2 via the line C.

The packet from the Internet 2 is input from the physical port 10b to the logical port via the line C. The packet is forwarded by the MAC frame processing section 21 and the IP processing section 22, and is then output to the signal line 3 via the substitute port 10c. Under the switching repeater operation, the packet passes through the substitute port 10c, the logical port and the physical port 10a, and is transmitted to the PC1 via the line B.

As explained above, according to the system of a virtual router shown in the first embodiment, substitute ports separate from the physical ports are provided in both routers that constitute the virtual router. These substitute ports are connected to each other via a signal line. When the line has been disconnected, the router in a backup state is changed to a master state. Further, the packet is transmitted on the route via these substitute ports. Therefore, even when one line of each router has been disconnected, it becomes possible to carry out satisfactory packet communications. As a result, it becomes possible to improve the transmission efficiency of packet forwarding.

There has been described in the above a transition of the state of a router itself from a backup state to a master state. However, this invention is not limited to the above. It is also possible to change the state of a logical port to a master state. This will be explained in the following embodiment.

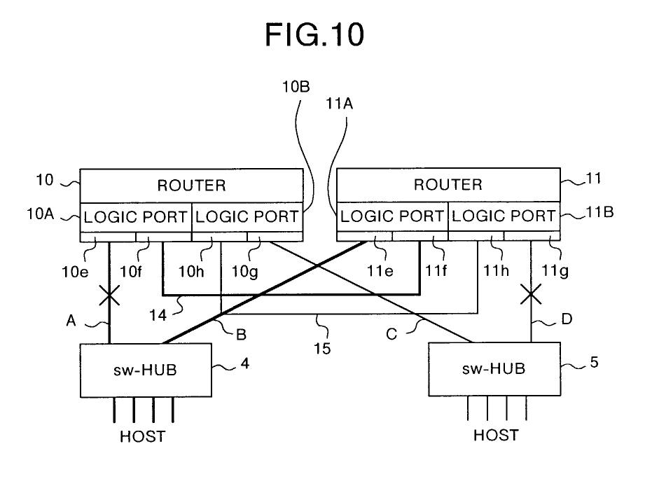

FIG. 10 is a configuration diagram which shows a structure of a system of a virtual router using the VRRP according to a second embodiment of this invention. In FIG. 10, routers 10 and 11 have two logical ports 10A and 10B, and 11A and 11B respectively. Each of the logical ports 10A, 10B, 11A and 11B has been set in advance with a VRID, a representative address, a priority, and a substitute port.

In the lower layer of each of the logical ports 10A, 10B, 11A and 11B, there exist one physical port and one substitute port. In other words, as shown in FIG. 10, in the router 10, a physical port 10e and a substitute port 10f exist in the logical port 10A, and a physical port 10g and a substitute port 10h exist in the logical port 10B. Further, in the router 11, a physical port 11e and a substitute port 11f exist in the logical port 11A, and a physical port 11g and a substitute port 11h exist in the logical port 11B.

In this system, the routers 10 and 11 are connected to witching hubs 4 and 5 via each port respectively. In other words, in the router 10, the physical port 10e is connected to the switching hub 4 via a line A, and the physical port 10g is connected to the switching hub 5 via a line C. In the router 11, the physical port 11e is connected to the switching hub 4 via a line B, and the physical port 11g is connected to the switching hub 5 via a line D. The switching hubs 4 and 5 are connected to a host unit not shown on the same network.

Between the routers 10 and 11, the substitute ports 10f and 11f are connected to each other via a signal line 14, and the substitute ports 10h and 11h are connected to each other via a signal line 15.

When these routers 10 and 11 are structured to operate as a switch of the layer 3, these routers have IP networks that are different in each physical port. When these routers 10 and 11 constitute a virtual router, the routers 10 and 11 are grouped in a logical port unit, and have a VRRP state (a master state or a backup state) in each logical port.

A logical port in the master state carries out a normal data transfer operation when the logical port has received a packet that is destined to a representative MAC address. When the logical port in the backup state, the logical port discards the whole packet after receiving this packet. However, when the logical port has received a packet from other logical port, the logical port can transmit the packet so as to be able to carry out a data transfer.

Assume that the logical ports 10A and 10B of the router 10 are in the master state, and the logical ports 11A and 11B of the router 11 are in the backup state, as an initial state. Also, assume that the line A has been disconnected in this state. In this instance, an advertisement packet that has been output from the logical port 10A to the line A does not reach the logical port 11A via the switching hub 4 and the line B, because of the disconnection. Therefore, after the expiration of the master down timer, the router 11 changes the state of the logical port 11A from the backup state to the master state.

With the above arrangement, the packet transmission from the switching hub 4 to the switching hub 5 is carried out as follows. The packet is first transferred from the switching hub 4 to the physical port 11e via the line B (a transfer in the layer 2 level). Then, the packet is transferred from the logical port 11A to the logical port 11B (a transfer in the layer 3 level). The packet is transferred from the physical port 11gto the switching hub 5 via the line D. In this instance, although the logical port 11B is in the backup state, the logical port 11B can carry out the transmission. However, as it is not possible to transmit from a logical port in a backup state to a logical port in a master state, the substitute port 11h cannot transmit the packet to the substitute port 10h.

A packet transmission from the switching hub 5 to the switching hub 4 is carried out as follows. The packet is first transferred from the switching hub 5 to the physical port 10g via the line C. Then, the packet is transferred from the logical port 10B to the logical port 10A (a transfer in the layer 3 level). The packet is transferred from the substitute port 10f to the substitute port 11f via the signal line 14. Further, the packet is transferred from the physical port 11e to the switching hub 4 via the line B (a transfer in the layer 2 level)

Assume that the line D has been disconnected in this state. In this instance, a packet transmission from the switching hub 4 to the switching hub 5 is carried out as follows. The packet is transferred from the switching hub 4 to the physical port 11e via the line B (a transfer in the layer 2 level). Next, the packet is transferred from the logical port 11A to the logical port 11B (a transfer in the layer 3 level). The packet is transferred from the substitute port 11h to the physical port 10h via the signal line 15. Further, the packet is transferred from the physical port 10h to the physical port 10g (a transfer in the layer 2 level), and is transferred from the physical port 10g to the switching hub 5 via the line C.

A packet transmission from the switching hub 5 to the switching hub 4 is carried out in a similar manner to that when only the line A has been disconnected.

As explained above, according to the system of a virtual router shown in the second embodiment, two substitute ports that are separate from the physical ports are provided in both routers that constitute the virtual router. Both substitute ports are connected to each other, and a master state and a backup state are set to each logical port. Therefore, it is possible to set an independent state to each logical port. Further, it becomes possible to increase the applicability of the virtual router.

According to the second embodiment, it is possible to set two series of substitute routes by connecting routers each having two substitute ports. Therefore, even when one substitute port has been disconnected, it is possible to use the other substitute route. Further, it becomes possible to increase the applicability of the virtual router. As a result, it is possible to improve the transmission efficiency of the packet forwarding.

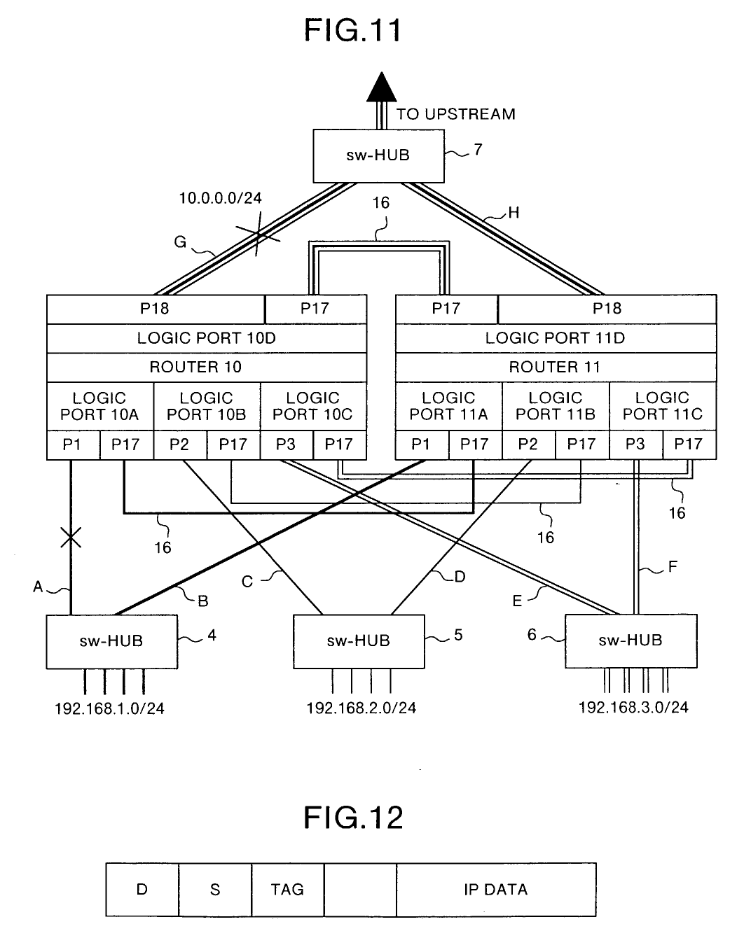

FIG. 11 is a configuration diagram which shows a structure of a system of a virtual router using the VRRP according to a third embodiment of this invention. Referring to FIG. 11, in this system, routers 10 and 11 have eighteen physical ports respectively. One of the physical ports P17 is used as substitute ports that substitute a plurality of physical ports 10A to 10D and 11A to 11D. For this purpose, in the third embodiment, a tag that identifies an existing VLAN is added to a MAC packet as shown in FIG. 12, and this packet is transmitted. This makes it possible to specify a logical port. In FIG. 12, D represents a destination address within the MAC header, and S represents a transmitter address.

In FIG. 11, the routers 10 and 11 have four logical ports 10A to 10D, and 11A to 11D respectively. Each logical port has been set in advance with a VRID, a representative address, a priority, and a substitute port, in a similar manner to that of the second embodiment.

In the lower layer of each of these logical ports, there exist one physical port and one substitute port. In other words, in the router 10, a physical port P1 and a substitute port P17 exist in the logical port 10A, and a physical port P2 and a substitute port P17 exist in the logical port 10B. A physical port P3 and a substitute port P17 exist in the logical port 10C. Further, in the router 11, a physical port P1 and a substitute port P17 exist in the logical port 11A, and a physical port P2 and a substitute port P17 exist in the logical port 11B. A physical port P3 and a substitute port P17 exist in the logical port 11C.

In this system, the routers 10 and 11 are connected to witching hubs 4 to 7 via each port respectively. In other words, in the router 10, the physical port P1 is connected to the switching hub 4 via a line A, and the physical port P2 is connected to the switching hub 5 via a line C. The physical port P3 is connected to the switching hub 6 via a line E, and a physical port P18 is connected to the switching hub 7 via a line G.

In the router 11, the physical port P1 is connected to the switching hub 4 via a line B, and the physical port P2 is connected to the switching hub 5 via a line D. The physical port P3 is connected to the switching hub 6 via a line F, and a physical port P18 is connected to the switching hub 7 via a line H.

Between the routers 10 and 11, the substitute ports P17 and P17 are connected to each other via a signal line 14, and the substitute ports 10h and 11h are connected to each other via a signal line 16. FIG. 11 shows logical connections of the ports. Therefore, the substitute port P17 in the router 10 and the substitute port P17 in the router 11, and the signal lines 16 are shown as a plurality of lines. However, these substitute ports are actually in one substitute port, and these signal lines are in one signal line. Other conditions relating to the routers 10 and 11 are similar to those of the second embodiment.

It is assumed that, in the initial state, all the logical ports of the router 10 are in the master state, and all the logical ports of the router 11 are in the backup state. A route to the upstream that is connected to the Internet or the like is also backed up according to the VRRP. In all instances, a packet passes through the router 10. Each of the switching hubs 4 to 7 interprets the contents of the tag included in the packet, and forwards the packet to a suitable port to which the VLAN belongs.

In this state, a packet transfer from the switching hub 4 to the switching hub 5 is carried out in the following route. The packet is transferred from the hub 4 to the physical port P1, the logical port 10A, the logical port 10B, and the physical port P2 of the router 10 respectively, to the hub 5. Further, a packet transfer from the switching hub 6 to the upstream is carried out in the following route. The packet is transferred from the hub 6 to the physical port P3, the logical port 10C, the logical port 10D, and the physical port P18 of the router 10 respectively, to the hub 7 and to the upstream.

Assume that the line A has been disconnected, and the advertisement packet does not reach the logical port 11A of the router 11. In this instance, after waiting for the expiration of the master down timer, the state of the logical port 11A is changed to the master state. Consequently, a packet transfer from the hub 4 to the hub 5 is carried out in the route from the hub 4 to the physical port P1, the logical port 11A, the logical port 11B, and the physical port P2 of the router 11 respectively, to the hub 5. Further, a packet transfer from the hub 5 to the hub 4 is carried out in the following route. The packet is transferred from the hub 5 to the physical port P2, the logical port 10B, the logical port 10A, and the substitute port P17 of the router 10 respectively, to the substitute port P17 and the physical port P1 of the router 11 respectively, and to the hub 4.

A packet transfer from the hub 4 to the upstream is carried out in the following route. The packet is transferred from the hub 4 to the physical port P1, the logical port 11A, the logical port 11D and the physical port P18 of the router 11 respectively, to the hub 7 and to the upstream. Further, a packet transfer from the upstream to the hub 4 is carried out in the following route. The packet is transferred from the upstream to the hub 7, to the physical port P18, the logical port 10D, the logical port 10A and the substitute port P17 of the router 10 respectively, to the substitute port P17 and the physical port P1 of the router 11 respectively, and to the hub 4.

Assume that the line G has been further disconnected in this state, and the advertisement packet does not reach the logical port 11D of the router 11. In this instance, after waiting for the expiration of the master down timer, the state of the logical port 11D is changed to the master state. Consequently, a packet transfer from the hub 6 to the upstream is carried out in the following route. The packet is transferred from the hub 6 to the physical port P3, the logical port 10C, the logical port 10D and the substitute port P17 of the router 10 respectively, to the substitute port P17 and the physical port P18 of the router 11 respectively, to the hub 7 and to the upstream. Further, a packet transfer from the upstream to the hub 6 is carried out in the following route. The packet is transferred from the upstream to the hub 7, to the physical port P18, the logical port 11D, the logical port 11C and the physical port P3 of the router 11 respectively, and to the hub 6.

A packet transfer from the hub 4 to the upstream is carried out in the following route. The packet is transferred from the hub 4 to the physical port P1, the logical port 11A, the logical port 11D and the physical port P18 of the router 11 respectively, to the hub 7 and to the upstream. Further, a packet transfer from the upstream to the hub 4 is carried out in the following route. The packet is transferred from the upstream to the hub 7, to the physical port P18, the logical port 11D, the logical port 11A and the physical port P1 of the router 11 respectively, and to the hub 4.

As explained above, according to the system of a virtual router shown in the third embodiment, one substitute port that substitutes a plurality of physical ports is allocated to each of the two routers. These substitute ports are connected to each other between the routers. Further, a VRRP state is set to each logical port, and it is possible to recognize the VLAN by using a tag VLAN. Therefore, it is possible to set an independent state to each logical port. Consequently, one substitute port can be allocated to set as if theoretically mutually different substitute ports exist in the logical ports. Further, it becomes possible to increase the applicability of the virtual router. As a result, it is possible to improve the transmission efficiency of a packet forwarding.

In the third embodiment, the VLAN typo is recognized based on the tag added to the packet of the MAC, and the packet is transferred to the corresponding logical port. According to this invention, it is possible to use any identifier when the identifier can recognize the logical port of the transfer destination, without limiting to the above tag.

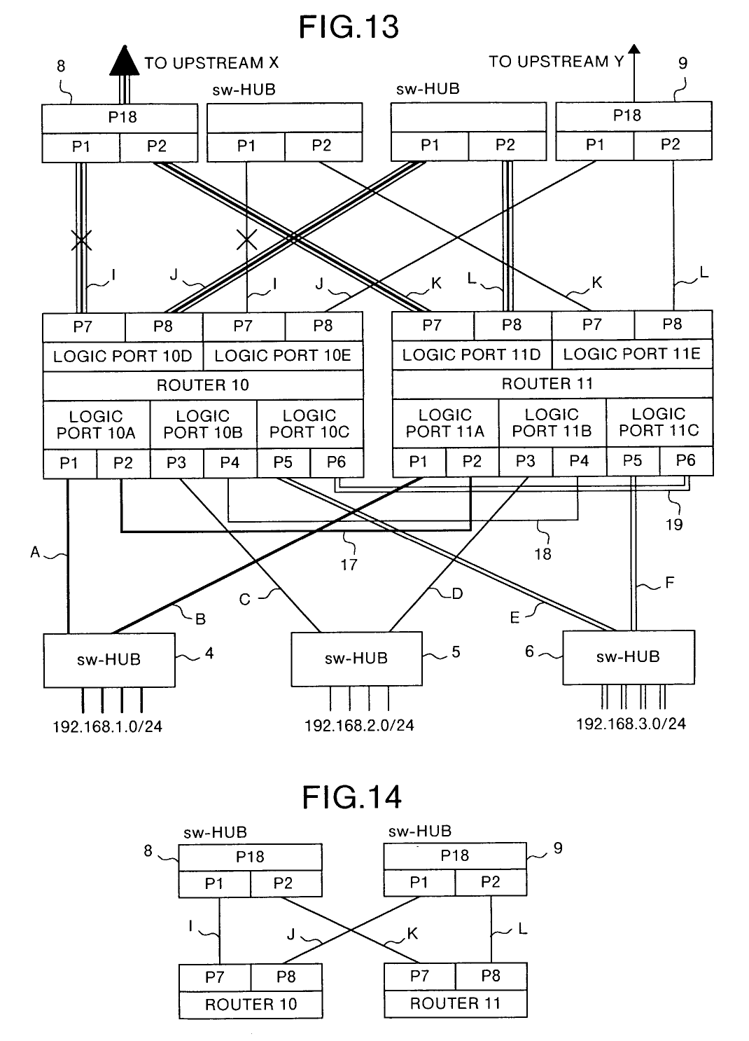

FIG. 13 is a configuration diagram which shows a structure of a system of a virtual router using the VRRP according to a fourth embodiment of this invention. In FIG. 13, routers 10 and 11 have five logical ports 10A to 10E, and 11A to 11E respectively. In the lower layer of each of these ports 10A to 10E, and 11A to 11E, there exist one physical port and one substitute port.

In other words, in the router 10, the logical port 10A has a physical port P1 and a substitute port P2, the logical port 10B has a physical port P3 and a substitute port P4, and the logical port 10C has a physical port P5 and a substitute port P6. The logical port 10D has a physical port P7 and a substitute port P8, and the logical port 10E has a physical port P8 and a substitute port P7. Further, in the router 11, the logical port 11A has a physical port P1 and a substitute port P2, the logical port 11B has a physical port P3 and a substitute port P4, and the logical port 11C has a physical port P5 and a substitute port P6. The logical port 11D has a physical port P7 and a substitute port P8, and the logical port 11E has a physical port P8 and a substitute port P7.

In the routers 10 and 11, the same ports P7 and P8 exist in the two logical ports 11D and 11E. This shows that the physical ports that are normally used are shared as substitute ports. These ports P7 and P8 are connected to switching hubs 8 and 9 at the upstream X and Y sides in which the same ports P1 and P2 exist. In the fourth embodiment, a tag that identifies an existing VLAN is added to a MAC packet, and this packet is transmitted, like in the third embodiment. With this arrangement, it is possible to specify a logical port, and it is possible to make clear whether a transmitted packet is an original packet that is normally used or a packet that uses a physical port as a substitute port.

Referring to FIG. 13, in the router 10, the port P7 is connected to the port P1 of a hub 8 via a line I. The port P8 is connected to the port P1 of a hub 9 via a line J. Further, in the router 11, the port P7 is connected to the port P2 of the hub 8 via a line K, and the port P8 is connected to the port P2 of the hub 9 via a line L.

In the logical ports 10D and 11D of the above structure, the respective ports P7 show physical ports, and the respective ports P8 show substitute ports. In the logical ports 10E and 11E, the respective ports P7 show substitute ports, and the respective ports P8 show physical ports. FIG. 13 shows logical connections of the ports. Therefore, a logical connection according to the VLAN is actually shared with one physical line as shown in FIG. 14.

In this system, the routers 10 and 11 are connected to switching hubs 4 to 6, 8 and 9 respectively via ports. In other words, in the router 10, the physical port P1 is connected to the switching hub 4 via a line A, and the physical port P3 is connected to the switching hub 5 via a line C. The physical port P5 is connected to the switching hub 6 via a line E, the physical port P7 of the logical port 10D is connected to the switching hub 8 via the line I, and the physical port P7 of the logical port 10E is connected to the line.

Between the routers 10 and 11, the substitute ports P2 are connected to each other via a signal line 17, the substitute ports P4 are connected to each other via a signal line 18, and the substitute ports P6 are connected to each other via a signal line 19. Other conditions relating to the routers 10 and 11 are similar to those of the second embodiment.

It is assumed that, in the above structure, all the logical ports of the router 10 are in the master state, and all the logical ports of the router 11 are in the backup state, in the initial state. In all instances, a packet passes through the router 10. Each of the switching hubs 8 and 9 interprets the contents of the tag included in the packet, and forwards the packet to a suitable port to which the VLAN belongs.

In this state, a packet transfer from the switching hub 4 to the upstream X is carried out in the following route. The packet is transferred from the hub 4 to the physical port P1, the logical port 10A, the logical port 10D, and the physical port P2 of the router 10 respectively, to the physical port P1 and the physical port P18 of the hub 8, and to the upstream.

A packet transfer from the switching hub 6 to the upstream Y is carried out in the following route. The packet is transferred from the hub 6 to the physical port P5, the logical port 10C, the logical port 10E and the physical port P8 of the router 10 respectively, to the physical port P1 and the physical port P18 of the hub 9, and to the upstream Y.

Assume that the line I has been disconnected, and the advertisement packet does not reach the logical port 11D of the router 11. After waiting for the expiration of the master down timer, the state of the logical port 11D is changed to the master state. In this instance, the line I between the substitute port P7 of the logical port 10E and the substitute port P1 of the hub 8 is also in the disconnection state. As the advertisement packet is not transmitted from the substitute port, the logical port 11E maintains the backup state.

In this state, a packet transfer from the switching hub 4 to the upstream X is carried out in the following route. The packet is transferred from the hub 4 to the physical port P1, the logical port 10A, the logical port 10D and the substitute port P8 of the router 10 respectively, to the substitute port P1 and the physical port P2 of the hub 9, to the substitute port P8 and the physical port P7 of the router 11 (the logical port 11D), to the physical port P2 and the physical port P18 of the hub 8, and to the upstream X.

A packet transfer from the upstream X to the switching hub 4 is carried out in the following route. The packet is transferred from the upstream X to the physical port P18 and the physical port P2 of the hub 8, to the physical port P7, the logical port P11D, the logical port 11A and the physical port P1 of the router 11 (the physical port 11D) respectively, and to the hub 4.

For example, a packet transfer from the switching hub 5 to the upstream Y is carried out in the following route. The packet is transferred from the switching hub 5 to the physical port P3, the logical port 10B, the logical port 10E and the physical port P8 of the router 10 respectively, to the physical port P1 and the physical port P18 of the hub 9, and to the upstream Y.

A packet transfer from the upstream Y to the switching hub 5 is carried out in the following route. The packet is transferred from the upstream Y to the physical port P18 and the physical port P1 of the hub 5, to the physical port P8, the logical port 10E, the logical port 10B and the physical port P3 of the router 10 (the logical port 10E) respectively, and to the hub 5.

As explained above, according to the system of a virtual router shown in the fourth embodiment, ports that are normally used are shared as substitute ports. The substitute ports are connected to the switching hubs of the tag VAN. At the same time, the VRRP is set to each logical port, and the VLAN is recognized using the tag VLAN. Therefore, it is possible to set a state to each logical port. As a result, it becomes possible to execute the forwarding of an original packet having no setting of a VLAN and the forwarding of a VRRP packet using substitute ports, by distinguishing between the two types of packets.

A router in a master state transmits an advertisement packet to a router in a backup state as described above. In the instance of the system of a virtual router shown in FIG. 10, for example, the router in the master state transmits the advertisement packet at every one second interval. The master down timer of the router in the backup state is set to three seconds. In other words, when the router in the backup state has not received the advertisement packet within three seconds after the master down timer is restarted, the state of this router is changed from the backup state to the master state.

Therefore, when the line A in FIG. 10 has been disconnected, maximum three seconds are necessary for the router 11 to change its state to the master state and change over the data forwarding. During this period, a data forwarding is not carried out, and the reliability of the data forwarding is lowered.

In a fifth embodiment, in order to shorten the time taken to change the state of a router from a backup state to a master state thereby achieving an instant transition of the router state, a detecting unit is provided. The detecting unit which detects that a physical port connected to the own router is down, is provided in each physical I/F 20 (refer to FIG. 2) of the routers 10 and 11. Any kind of detecting unit can be used that detects a physical signal level (for example, a voltage level) of a physical port, and decides that the physical port is down when the signal level is lower than a certain threshold value.

When the line A has been disconnected at the physical port 10e of the router 10 shown in FIG. 10, the physical I/F 20 of the router 10 detects that the physical port 10e is down, based on a reduction in the signal level of the physical port 10e. The physical I/F 20 notifies a result of the detection to the VRRP processing section 23. Upon reception of this notification, the VRRP processing section 23 transmits the advertisement packet of priority zero to the substitute port 10f.

The advertisement packet of priority zero has been defined in the VRRP recommendation RFC2338. This recommendation shows that the advertisement packet of priority zero is used to notify that a router in the master state quits the participation in the VRRP.

In this invention, the advertisement packet of priority zero is used, as the router in the backup state that has received this advertisement packet is instantly changed to the master state.

The advertisement packet of priority zero that has been transmitted from the router 10 is input from the logical port 10f to the physical port 11f of the router 11 via the signal line 14. This advertisement packet is processed in each layer in the MAC frame processing section 21 and the IP processing section 22 of the router 11, and is then taken into the VRRP processing section 23. Upon taken in the advertisement packet of priority zero, the VRRP processing section 23 rewrites the state from the backup state to the master state in the VRRP state table 21c within the processing section.

In this rewriting, it is possible to change over the state of the corresponding logical port 11A to the master state, or change over the state of the whole router 11 to the master state.

After finishing the rewriting, the router 11 notifies to the router 10 that the router 11 has been changed to the master router, by transmitting the advertisement packet to the router 10.

As explained above, the system of a virtual router shown in the fifth embodiment detects that a physical port is down. When it has been detected that the physical port is down, the master router transmits the advertisement packet of priority zero to the backup router. The state of the backup router that has received this advertisement packet is instantly changed to the master state. Therefore, the backup router can promptly change to the master state, without waiting for the time-up of the master down timer. Consequently, it is possible to prevent a delay in the data forwarding, and it becomes possible to improve the reliability of the data forwarding.

As explained above, the advertisement packet is not transmitted from the substitute port in principle. However, as shown in the fifth embodiment, when the advertisement packet of priority zero is transmitted, the substitute port can transmit the advertisement packet, as the physical port is down. Further, the substitute port can also receive the packet in the backup state.

In the structure shown in FIG. 10, it is necessary that the system has learned the following in advance. When the line A has been disconnected, the packet to be transferred from the switching hub 5 to the switching hub 4 is forwarded to the physical port 10g, the logical port 10B and the logical port 10A via the line C, and to the physical port 10f. When the packet is forwarded to the physical port 10f, actually the forwarding processing function of the bridge in the layer 2 is used. Therefore, the MAC frame processing section searches for a destination MAC address by referring to a MAC address learning table stored inside, and it becomes possible to forward the packet to corresponding physical ports.

However, in the state before the line A has been disconnected, this destination MAC address is related to the physical port 10e by learning. Therefore, when this entry remains in the learning table, the packet is transmitted from the physical port 10e to the line A.

When the router 10 can physically detect the disconnection, for example, it is possible to clear the entered data based on the learning function. However, when the line has not been disconnected but there is some trouble between the physical port 10e of the router 10 and the physical port 11e of the router 11, it is necessary to overcome this problem. For example, when there exists a separate switching hub between the physical port 10e and the switching hub 4, there is a problem to be overcome. In this instance, the VRRP advertisement packet does not reach the router 11, and therefore, the state of the router 11 is changed over to the master state. However, the router 10 cannot recognize this state, and transmits the packet to the physical port 10e. Consequently, it becomes impossible to carry out communications.

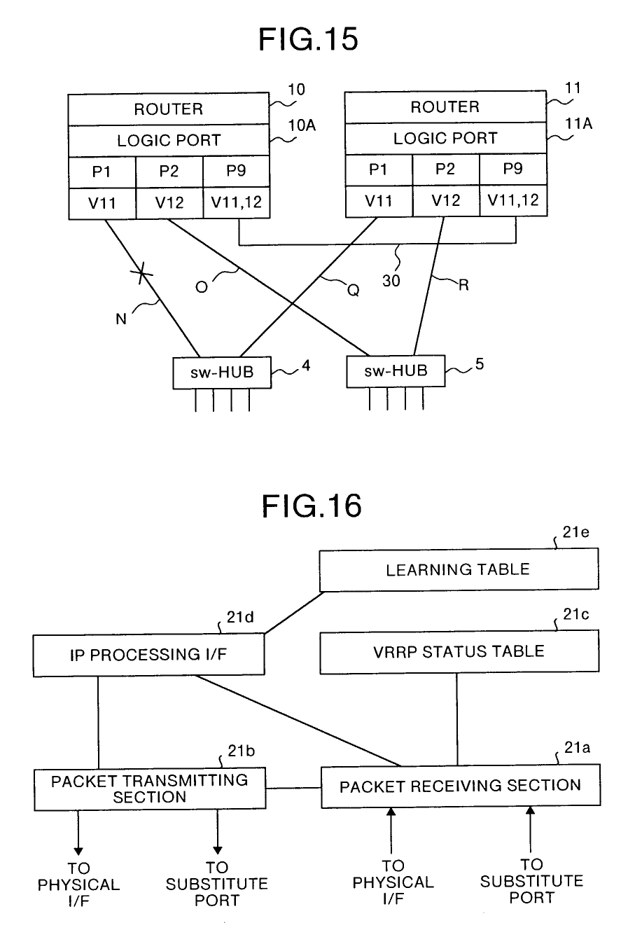

In order to solve this problem, the system of this invention is structured as shown in a configuration diagram in FIG. 15. The state of the logical port 11A of the router 11 is changed over from the backup state to the master state. Then, the router 11 transmits a transition notification packet to the effect that the state of the router 11 has been changed to the master state, from the substitute port P9 to the router 10 via the substitute port P9 of a routing T10. Then, the entry in the learning table of the router 10 is cleared.

In FIG. 15, an identifier V11 of VLAN is set to the physical port P1, an identifier V12 of VLAN is set to the physical port P2, and identifiers V11 and V12 of VLAN are set to the substitute port P9, of the routers 10 and 11 respectively.

A switching hub 4 is connected to the routers 10 and 11 via lines N and O respectively. A switching hub 5 is connected to the routers 10 and 11 via lines Q and R respectively.

FIG. 16 is a block diagram which shows a structure of a MAC frame processing section relating to this embodiment. FIG. 16 is different from FIG. 3 in that a learning table 21e that constitutes a bridge table of this invention is additionally provided. In this embodiment, the VRRP processing section has a similar structure to that shown in FIG. 4.

A packet receiving section 21a receives various kinds of packets that are input from a physical I/F and also receives a state notification packet that is input from the substitute port P9. The packet receiving section 21a outputs the received packets to a VRRP state managing section 23c via an IP processing I/F 21d.

A packet transmitting section 21b transmits a state notification packet according to an instruction from the VRRP state managing section 23c via the IP processing I/F 21d.

The learning table 21e stores destination MAC addresses, and data of physical ports corresponding to these addresses. The IP processing I/F 21d constitutes a table entry clearing unit of this invention. The IP processing I/F 21d writes and reads data to/from the learning table 21e, and clears a corresponding entry when a state notification packet has been input from the packet receiving section 21a.

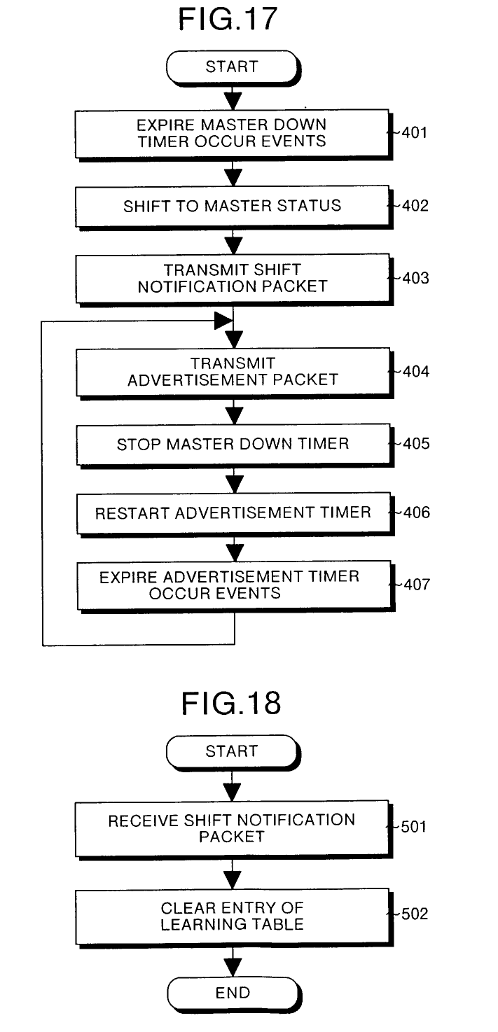

The operation of changing the state of the router from a backup state to a master state in the above structure will be explained with reference to a flowchart shown in FIG. 17. In FIG. 17, the VRRP packet transmitting section 23b and the VRRP state managing section 23c are monitoring the master down timer of the timer processing section 23d.

When the counting of the master down timer has expired (step 401), the VRRP state managing section 23c decides that a trouble has occurred on the other router or the line has been disconnected, and changes the router to a master state (step 402). The VRRP packet transmitting section 23b prepares a transition notification packet that contains the information of the physical port in which the trouble occurred, that is, the physical port P1 in this example. The VRRP packet transmitting section 23b transmits this transition notification packet to the substitute port P9 via the IP processing section 22 and the MAC frame processing section 21 (step 403).

The VRRP packet transmitting section 23b prepares an advertisement packet, and transmits this advertisement packet to the physical I/F via the IP processing section 22 and the MAC frame processing section 21. The physical I/F further transmits this advertisement packet to the physical port (step 404).

The VRRP packet transmitting section 23b controls the timer processing section 23d to stop the master down timer (step 405) and restart the advertisement timer (step 406). When the counting has expired after a lapse of a predetermined period of time since the advertisement timer restarted (step 407), the process returns to step 404 again, and the advertisement packet is transmitted.

With the above operation, the transition notification packet is transmitted to the other router 10 from the substitute port via the line. In principle, the transition notification packet is not transmitted from the physical port.

Referring to FIG. 18, the packet receiving section 21a of the router 10 receives the transition notification packet from the substitute port P9 (step 501). The IP processing I/F 21d decides that a trouble has occurred on the physical port P1 or the route connected to this physical port, from the information of the physical port P1 contained in this packet. Then, the IP processing I/F 21d clears the entry relating to this physical port P1 contained in the learning table 21e (step 502).

After the entry of this learning table 21e has been cleared, a packet to be forwarded next is input to the router 10. As there is no transfer destination data regarding data to be transmitted from the cleared physical port P1, the ports are set such that a packet is transmitted from all the physical ports P1 and P2 and the substitute port P9.

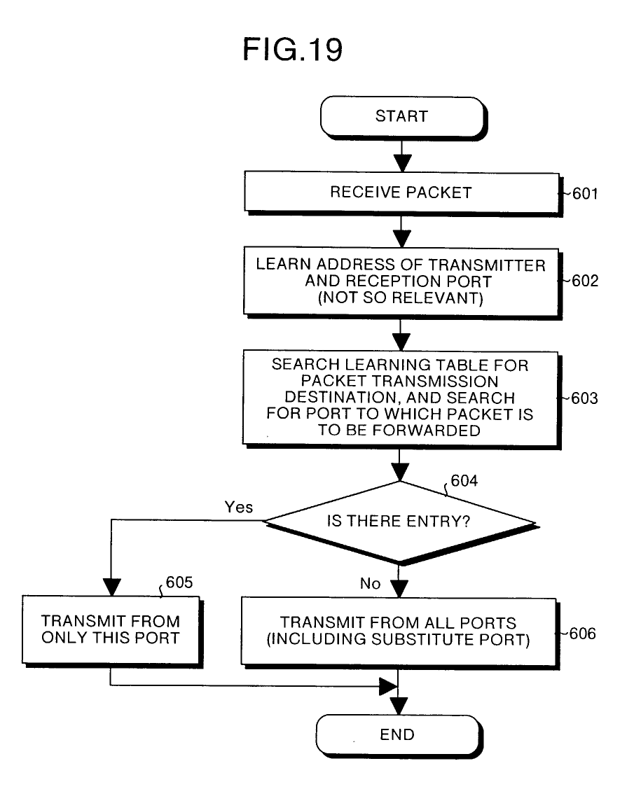

The packet forwarding operation after the entry of a learning table has been cleared will be explained with reference to a flowchart shown in FIG. 19. Referring to FIG. 19, when the packet receiving section 21a of the router 10 has received a packet (step 601), the IP processing I/F 21d learns the address of the transmitter and the reception port from the received packet (step 602).

The IP processing I/F 21d searches for the packet transmission destination by referring to the learning table 21e of the router 10, and searches for a port to which the packet is to be forwarded (step 603). The IP processing I/F 21d decides whether there is an entry that shows a port to which the packet is to be forwarded (step 604).

When there is an entry of a corresponding port, the packet is transmitted from only this port (step 605). When there is no entry of a corresponding port, this packet is transmitted from all ports including the substitute port P9 (step 606).

The substitute port P9 of the router 11 replies to the router 10 in response to this packet transmission. Then, the router 10 can enter this substitute port P9 in the learning table 21e to prepare for the next packet forwarding.

As a result, in FIG. 15, the packet to be transmitted from the switching hub 5 to the switching hub 4 is forwarded as follows. The physical port P2 of the router 10 receives the packet via the line O. Then, the packet is transmitted from the logical port 10A and the substitute port P9 to the router 11 via the signal line 30.

The substitute port P9 of the router 11 receives this packet via the signal line 30. Then, the packet is transmitted from the logical port 11A and the physical port P1 to the switching hub 4 via the line Q.

As explained above, in this embodiment, when a trouble has occurred, a router in the backup state transmits a transition notification packet to a router in the master state via the substitute port. This transition notification packet shows that the state of the router in the backup state has been changed to the master state. Therefore, the router in the master state can clear the entry of the learning table. With this arrangement, it becomes possible to forward the packet via the substitute port. Therefore, according to this embodiment, it is possible to perform a satisfactory data rely, even when one line has been disconnected due to the occurrence of a trouble in the route among a plurality of lines that are connected to the virtual router.

According to the conventional virtual router, the setting of a master state and a backup state of the VRRP is carried out for each logical port. This will be explained with reference to the system configuration diagram shown in FIG. 15. Assume that the logical port 10A of the router 10 has been set to a master state, and the logical port 11A of the router 11 has been set to a backup state. The line O connected to the physical port P2 is disconnected. Then, the logical port 10A of the master router 10 transmits the advertisement packet of the VRRP from the physical port P1 to the backup router 11 via the line N, the switching hub 4, and the line Q. The backup router 11 can receive this advertisement packet via the physical port P1. Therefore, the state of the logical port 11A of the backup router 11 is not changed to the master state.

Consequently, when transmitting a packet from the switching hub 4 to the switching hub 5, it is possible to forward the packet from the switching hub 4 to the physical port P1, the logical port 10A and up to the physical port P2 of the router 10 only. As the line O has been disconnected, it has been impossible to forward the packet any further.

Even when the packet is transmitted from the logical port 10A to the router 11 via the substitute port P9 and the signal line 30, the substitute port P9 of the router 11 discards the received packet, as the logical port 11A of the router 11 is in the backup state. Consequently, it has been impossible to forward the packet any further.

Therefore, this embodiment solves the above problem by setting a master state or a backup state of the VRRP to each physical port.

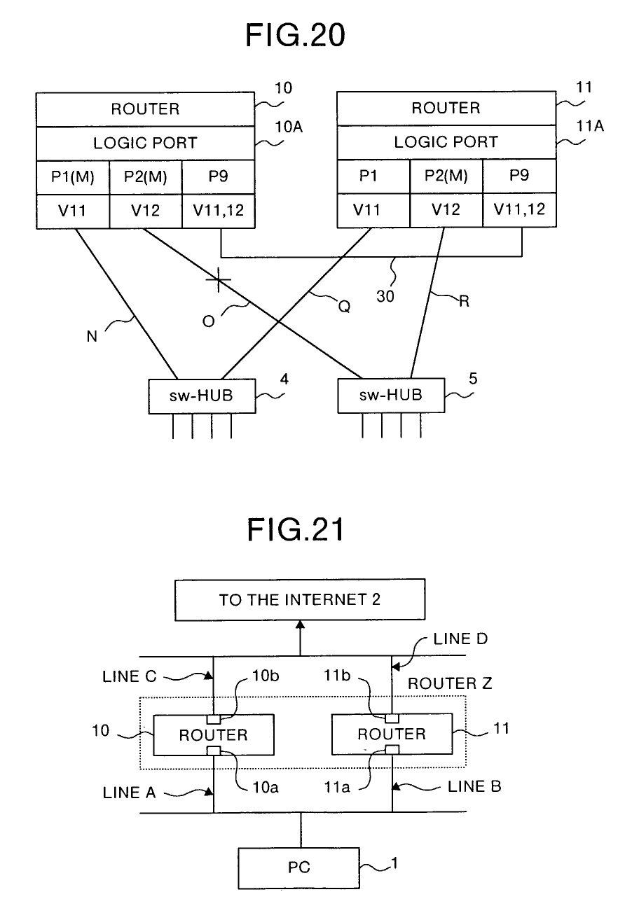

FIG. 20 is a configuration diagram which shows a structure of a system of a virtual router using the VRRP according to a seventh embodiment of this invention. The structure of the system shown in FIG. 20 is similar to that of FIG. 15, except that physical ports P1 and P2 of a router 10 are set to a master state in this embodiment. The structures of the routers are similar to those shown in FIG. 2 to FIG. 4, except the following. A VRRP packet transmitting section 23b and a VRRP packet state managing section 23c monitor a timer processing section 23d that is provided in each of the physical ports P1 and P2.

The operation that the physical port changes from a backup state to a master state in the above structure will be explained next. This operation will be explained with reference to the flowchart shown in FIG. 8, as these steps can be utilized as they are.

Assume that the line O has been disconnected. A packet does not reach the physical port P2 of the router 11 due to the disconnection of the line O. When the counting of the master down timer provided in the physical port P2 has expired (step 201), the VRRP state managing section 23c decides that a trouble has occurred on the other router 10 or the line O has been disconnected. Then, the state of the physical port P2 is changed to a master state (step 202).

The VRRP packet transmitting section 23b prepares an advertisement packet, and transmits this advertisement packet to the physical I/F via the IP processing section 22 and the MAC frame processing section 21. The physical I/F further transmits this advertisement packet to the physical port P1 (step 203).

The VRRP packet transmitting section 23b controls the timer processing section 23d to stop the master down timer provided in the physical port P2 (step 204) and restart the advertisement timer (step 205). When the counting has expired after a lapse of a predetermined period of time since the advertisement timer restarted (step 206), the process returns to step 203 again, and the advertisement packet is transmitted.

With the above operation, when the line O has been disconnected, the packet is transmitted from the logical port 10A to the substitute port P9 of the router 10 respectively, to the router 11 via the signal line 30. As the physical port P2 of the router 11 is in the master state, the substitute port P9 of the router 11 receives the packet, and forwards the packet to the switching hub 5 via the physical port P2 and the line R.

On the other hand, a packet is forwarded from the switching hub 5 to the switching hub 4 as follows. The packet is forwarded from the physical port P2 to the master router 11A and the physical port P1 of the router 11 respectively, to the switching hub 4 via the line Q.

The VLAN identifier that has been set to the physical port P2 is V12. In order to use the substitute port P9 to function as this V12, it is possible to decide whether the substitute port P9 is the VLAN represented by the identifier V12 or the VLAN represented by the identifier V11, by using a tag VLAN.

As explained above, according to this embodiment, it is possible to set a VRRP state for each physical port. Therefore, when a trouble has occurred, it is possible to forward the packet by changing the state of the VRRP of each physical port. Consequently, even when a line has been disconnected due to the occurrence of a trouble in the route, it is possible to perform satisfactory data forwarding. As a result, it is possible to improve the transmission efficiency of the packet forwarding.

This invention is not limited to the above embodiments, and it is possible to implement various modified embodiments of the invention within a scope not deviating from the gist of the invention.

In other words, while the virtual router has been explained in the above embodiments, this invention is not limited to this. It is also possible to use the system of the above embodiments to virtually build up one bridge by using a plurality of bridges.

While the LAN connected with PCs has been explained in the system of the above embodiments, it is also possible to apply this invention to a forwarding system between LANs connected with routers as forwarding units instead of PCs.

As explained above, according to one aspect of this invention, substitute ports of the interface separate from physical ports are provided in both routers that constitute the virtual router. These substitute ports of the virtual router are connected to each other via a signal line. When the line has been disconnected, the router in a backup state is changed to a master state. Further, a packet is transmitted on the route via these substitute ports. Therefore, even when a plurality of lines have been disconnected due to the occurrence of a trouble on the route among lines connected to the virtual router, it becomes possible to carry out satisfactory data communications. As a result, it becomes possible to improve the transmission efficiency of packet forwarding.

According to another aspect of this invention, identification addresses are provided in the routers, and a master state or a backup state is set to each router. According to a trouble on the route, a router in the backup state is changed over to a master state. At the same time, the packet is transferred using the physical port of the interface. Even when one transmission path of each router has been disconnected, it is possible to overcome the situation. Therefore, even when a plurality of lines have been disconnected due to the occurrence of a trouble on the route among lines connected to the virtual router, it becomes possible to carry out satisfactory data communications. As a result, it becomes possible to improve the transmission efficiency of packet forwarding.

According to still another aspect of this invention, each router has a plurality of interfaces. Each interface has a substitute port provided with an identification address. Each interface is set to a master state or a backup state. According to a trouble on the route, at least one interface in the backup state is changed over to a master state. The packet is transferred using this substitute port. Even when one transmission path of each router has been disconnected, it is possible to overcome the situation. Therefore, even when a plurality of lines have been disconnected due to the occurrence of a trouble on the route among lines connected to the virtual router, it becomes possible to carry out satisfactory data communications. As a result, it becomes possible to improve the transmission efficiency of packet forwarding.

According to still another aspect of this invention, when a trouble has occurred on the route, a router in the backup state transmits a packet that notifies a transition of the VRRP state, to a router in the master state via the substitute port. The router in the master state clears the entry of the bridge table that stores the information on physical ports of the interface that are packet transfer destinations and a packet output destination. With this arrangement, it is possible to transmit the packet from all ports including the substitute port. Therefore, even when lines have been disconnected due to the occurrence of a trouble on the route, it becomes possible to carry out satisfactory data communications. As a result, it becomes possible to improve the transmission efficiency of packet forwarding.

According to still another aspect of this invention, physical ports are set on the interface such that theoretically mutually different physical ports and substitute ports exist in the interfaces. A master state or a backup state is set to each physical port. A packet is transferred using this physical port in the master state. When a trouble has occurred, a packet is transferred using the substitute port. Therefore, even when lines have been disconnected due to the occurrence of a trouble on the route, it becomes possible to carry out satisfactory data communications. As a result, it becomes possible to improve the transmission efficiency of packet forwarding.

According to still another aspect of this invention, an identification address of the virtual network is given to the physical port. At least one number that is the same as this identification number given to the physical port is provided to the physical port. With this arrangement, it is possible to change over a route when a trouble has occurred on the route.

According to still another aspect of this invention, at least one physical port is allocated as a substitute port that substitutes a plurality of interfaces and this physical port is set such that theoretically mutually different substitute ports exist in the interfaces. The packet is provided with an identifier that specifies a virtual network. An allocating unit which allocates the packet specifies the interface to which the virtual network belongs according to the identifier. The packet is transferred to the physical port of the specified interface. Therefore, even when one transmission path of each router has been disconnected, it is possible to overcome the situation, by efficiently using the physical port.

According to still another aspect of this invention, at least two physical ports are allocated such that theoretically mutually different physical ports and substitute ports exist in a plurality of interfaces. Therefore, even when one transmission path of each router has been disconnected, it is possible to overcome the situation, by efficiently using the physical port.

According to still another aspect of this invention, when the router is in the backup state, the packet received from the substitute port is discarded. Only the router in the master state can receive the packet. Therefore, it is possible to avoid redundancy of the packet.

According to still another aspect of this invention, when it has been detected that the physical port is down due to a disconnection of the line, the advertisement packet of priority zero is transmitted to the router in the backup state to notify this down state. Therefore, it becomes possible to urge this router to promptly change to the master state.

According to still another aspect of this invention, the advertisement packet of priority zero is transmitted from the substitute port, thereby to make it possible to achieve a prompt notification.

According to still another aspect of this invention, there is provided a system for comprising the virtual router having the substitute ports of the routers connected to each other. When a trouble has occurred on the route, that is, when a transmission path has been disconnected, for example, the packet is transferred via these substitute ports. Therefore, even when the line has been disconnected due to the occurrence of a trouble on the route, it becomes possible to carry out satisfactory packet communications. As a result, it becomes possible to improve the transmission efficiency of packet forwarding.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method for connecting between networks, wherein
a plurality of routers connected within the same network are set in a relationship of a master and a backup according to the mounted VRRP, thereby to build up a virtual router, the virtual router transmitting a packet input from the network or an external network to a destination network, and
each router has at least one substitute port of an interface, connects the own substitute port to substitute ports of other routers with each other, and transfers the packet by using the substitute ports when a trouble has occurred on the route.

2. The method according to claim 1, wherein
each router is provided with an identification address, and is set to either a master state or a backup state, and a router in the backup state is changed over to a master state according to a trouble on the route, and transfers the packet by using the physical port of the interface.

3. The method according to claim 1, wherein
each router has a plurality of interfaces in which a substitute port provided with an identification address exists, each interface is set to a master state or a backup state, and at least one interface in the backup state is changed over to a master state according to a trouble on the route, and transfers the packet by using the substitute port.

4. The method according to claim 1, wherein
each router is provided with an identification address, and is set to either a master state or a backup state, a router in the backup state transmits a packet that notifies a transition of the state when a trouble has occurred on the route, to a router in the master state via the substitute port, and the router in the master state clears the entry of a bridge table that stores the information on the interface physical ports that are packet transfer destinations and a packet output destination.

5. The method according to claim 4, wherein
the router in the master state receives the transition notification packet via the substitute port.

6. The method according to claim 1, wherein
ports are set to each interface such that a physical port and a substitute port that are theoretically mutually different exist in the interface, each physical port is set to either a master state or a backup state, and the packet is transferred by using the substitute port when a trouble has occurred on the route.

7. The method according to claim 4, wherein
the physical port is provided with an identification number of a virtual network, and the substitute port is provided with at least one number that is the same as the identification address provided to the physical port.

8. The method according to claim 1, wherein
a physical port normally used in the interface is allocated as the substitute port that has been set such that theoretically mutually different substitute ports exist, or a port that has been provided separately from the physical port normally used.

9. The method according to claim 1, wherein
at least one physical port among physical ports that exist in the router is allocated as a substitute port of a plurality of interfaces and this physical port is set such that theoretically mutually different substitute ports exist in the interfaces, the substitute ports are connected to each other, the packet is provided with an identifier that specifies a virtual network, and an allocating unit which allocates the packet specifies the interface to which the virtual network belongs according to the identifier, and transfers the packet to the physical port of the specified interface.

10. The method according to claim 1, wherein
at least two physical ports that are used in the interfaces are allocated as a physical port and a substitute port of the plurality of interfaces and are set such that theoretically mutually different physical ports and substitute ports exist in the interfaces, the physical ports that are normally used and the substitute ports are connected with an allocating unit which allocates the packets, the packet is provided with an identifier that specifies a virtual network, and the allocating unit specifies the interface to which the virtual network belongs according to the identifier, and transfers the packet to the physical port of the specified interface.

11. The method according to claim 1, wherein
when the router in the backup state has received a packet from the substitute port, the router discards the packet.

12. The method according to claim 1, wherein
the router in the master state detects that the physical port is down, and transmits an advertisement packet of priority zero, when the physical port is down, and the router in the backup state receives the advertisement packet of priority zero, and changes the own state to the master state.

13. The method according to claim 12, wherein
the router in the master state transmits the advertisement packet of priority zero from the substitute port.

14. A virtual router which is constructed of a plurality of routers that are connected within the same network and are set in a relationship of a master and a backup by using the VRRP, and which transfers an input packet, wherein
each router comprises:
at least one substitute port of an interface;
a connecting unit which connects between the substitute ports of the own router and the other routers;
a state changeover unit which changes over the state of the router from a backup state to a master state according to a trouble on the route; and
a transfer unit which transfers the packet by using the substitute port when a trouble has occurred on the route.

15. The virtual router according to claim 14, further comprising:
a state notifying unit which transmits a packet that notifies a transition of the state when a trouble has occurred on the route; and
a bridge table that stores the information on physical ports of an interface that are packet transfer destinations and a packet output destination, and a table entry clearing unit which clears the entry of the bridge table when the transition notification packet has been received.

16. The virtual router according to claim 15, wherein
when the table entry clearing unit of the router in the master state has received the transition notification packet via the substitute port, the table entry clearing unit clears the entry of the bridge table.

17. The virtual router according to claim 14, wherein
each router has a physical port and a substitute port of the interface that have been set to exist logically and that are different from each other, and each physical port is set with a master state and a backup state.

18. The virtual router according to claim 17, wherein
the physical port is provided with an identification address of a virtual network, and the substitute port is provided with at least one number that is the same as the identification number provided to the physical port.

19. The virtual router according to claim 14, wherein
a physical port normally used in the interface is allocated as the substitute port that has been set such that theoretically mutually different substitute ports exist, or a port that has been provided separately from the physical port normally used.

20. The virtual router according to claim 14, wherein
when the interface in the backup state has received a packet from the substitute port, the interface discards the packet.

21. The virtual router according to claim 14, wherein
the packet is provided with an identifier that specifies a virtual network, the interface to which the virtual network belongs is specified according to the identifier, and the packet is transferred to the physical port of the specified interface.

22. The virtual router according to claim 14, further comprising:
a detecting unit which detects that the physical port is down; and
a transmitting unit which transmits an advertisement packet of priority zero, wherein
the state changeover unit changes over the state of the router or the interface from a backup state to a master state, when the advertisement packet has been received.

23. The virtual router according to claim 22, wherein
the transmitting unit transmits the advertisement packet from the substitute port.

24. A virtual router which is constructed of a plurality of routers that are connected within the same network and are set in a relationship of a master and a backup using the VRRP, wherein
each router comprises:
an interface that is provided with an identification address and is set to a master state or a backup state, and that transmits a packet via a physical port;
at least one substitute port that exists separately from the physical port of the interface;
a connecting unit which connects between substitute ports of the own router and the other routers respectively;
a state changeover unit which changes over the state of the interface from a backup state to a master state according to a trouble on the route; and
a transfer unit which transfers the packet by using the substitute port when a trouble has occurred on the route.

25. The virtual router according to claim 24, wherein
each router has a physical port and a substitute port of the interface that have been set to exist logically and that are different from each other, and each physical port is set with a master state and a backup state.

26. The virtual router according to claim 25, wherein
the physical port is provided with an identification address of a virtual network, and the substitute port is provided with at least one number that is the same as the identification number provided to the physical port.

27. The virtual router according to claim 24, wherein
a physical port normally used in the interface is allocated as the substitute port that has been set such that theoretically mutually different substitute ports exist, or a port that has been provided separately from the physical port normally used.

28. The virtual router according to claim 24, wherein
when the interface in the backup state has received a packet from the substitute port, the interface discards the packet.

29. The virtual router according to claim 24, wherein
the packet is provided with an identifier that specifies a virtual network, the interface to which the virtual network belongs is specified according to the identifier, and the packet is transferred to the physical port of the specified interface.

30. The virtual router according to claim 24, further comprising:
a detecting unit which detects that the physical port is down; and
a transmitting unit which transmits an advertisement packet of priority zero, wherein
the state changeover unit changes over the state of the router or the interface from a backup state to a master state, when the advertisement packet has been received.

31. The virtual router according to claim 30, wherein
the transmitting unit transmits the advertisement packet from the substitute port.

32. A virtual router which is constructed of a plurality of routers that are connected within the same network and are set in a relationship of a master and a backup using the VRRP, wherein
each router comprises:
a plurality of interfaces each of which is provided with an identification address and is set to a master state or a backup state, and which transmits a packet via a physical port;
at least one substitute port that is allocated as a substitute port that substitutes the plurality of interfaces and that is set such that theoretically mutually different substitute ports exist in the interfaces;
a connecting unit which connects between substitute ports of the own router and the other router respectively;
a state changeover unit which changes over the state of the interface from a backup state to a master state according to a trouble on the route; and
a transfer unit which transfers the packet by using the substitute port when a trouble has occurred on the route.

33. The virtual router according to claim 32, wherein
when the interface in the backup state has received a packet from the substitute port, the interface discards the packet.

34. The virtual router according to claim 32, wherein
the packet is provided with an identifier that specifies a virtual network, the interface to which the virtual network belongs is specified according to the identifier, and the packet is transferred to the physical port of the specified interface.

35. The virtual router according to claim 32, further comprising:
a detecting unit which detects that the physical port is down; and
a transmitting unit which transmits an advertisement packet of priority zero, wherein
the state changeover unit changes over the state of the router or the interface from a backup state to a master state, when the advertisement packet has been received.

36. The virtual router according to claim 35, wherein
the transmitting unit transmits the advertisement packet from the substitute port.

37. A virtual router which is constructed of a plurality of routers that are connected within the same network and are set in a relationship of a master and a backup using the VRRP, wherein
each router comprises:
a plurality of interfaces each of which is provided with an identification address and is set to a master state or a backup state, and which transmits a packet via a physical port;
at least two physical ports that are normally used as ports of the interfaces, that are allocated as a physical port and a substitute port normally used in at least two interfaces, and that are set such that theoretically mutually different physical ports and substitute ports exist in the interfaces;
a state changeover unit which changes over the state of the interface from a backup state to a master state according to a trouble on the route; and
a transfer unit which transfers the packet by using the substitute port when a trouble has occurred on the route.

38. The virtual router according to claim 37, wherein
when the interface in the backup state has received a packet from the substitute port, the interface discards the packet.

39. The virtual router according to claim 37, wherein
the packet is provided with an identifier that specifies a virtual network, the interface to which the virtual network belongs is specified according to the identifier, and the packet is transferred to the physical port of the specified interface.

40. The virtual router according to claim 37, further comprising:
a detecting unit which detects that the physical port is down; and
a transmitting unit which transmits an advertisement packet of priority zero, wherein
the state changeover unit changes over the state of the router or the interface from a backup state to a master state, when the advertisement packet has been received.

41. The virtual router according to claim 40, wherein
the transmitting unit transmits the advertisement packet from the substitute port.

42. A system for connecting between networks having a virtual router constructed of a plurality of routers connected within the same network and set in a relationship of a master and a backup using the VRRP, a node that transmits a packet to the routers based on one set address, and transmission paths that connect between the routers, wherein
the virtual router is constructed of a plurality of routers that are connected within the same network and are set in a relationship of a master and a backup by using the VRRP, and transfers an input packet, each router comprising: at least one substitute port of an interface; a connecting unit which connects between the substitute ports of the own router and the other routers; a state changeover unit which changes over the state of the router from a backup state to a master state according to a trouble on the route; and a transfer unit which transfers the packet by using the substitute port when a trouble has occurred on the route, and the router transferring the packet via the substitute port according to a trouble on the route.

43. The system according to claim 42, wherein
the packet is provided with an identifier that specifies a virtual network, and
each router is further provided with an allocating unit which specifies the interface to which the virtual network belongs according to the identifier, and allocates the packet to the physical port of the specified interface.

44. A system for connecting between networks having a virtual router constructed of a plurality of routers connected within the same network and set in a relationship of a master and a backup using the VRRP, a node that transmits a packet to the routers based on one set address, and transmission paths that connect between the routers, wherein
the virtual router is constructed of a plurality of routers that are connected within the same network and are set in a relationship of a master and a backup by using the VRRP, each router comprising: an interface that is provided with an identification address and is set to a master state or a backup state, and that transmits a packet via a physical port; at least one substitute port that exists separate from the physical port of the interface; a connecting unit which connects between substitute ports of the own router and the other routers respectively; a state changeover unit which changes over the state of the interface from a backup state to a master state according to a trouble on the route; and a transfer unit which transfers the packet by using the substitute port when a trouble has occurred on the route, and the router transferring the packet via the substitute port according to a trouble on the route.

45. The system according to claim 44, wherein
the packet is provided with an identifier that specifies a virtual network, and
each router is further provided with an allocating unit which specifies the interface to which the virtual network belongs according to the identifier, and allocates the packet to the physical port of the specified interface.

46. A system for connecting between networks having a virtual router constructed of a plurality of routers connected within the same network and set in a relationship of a master and a backup using the VRRP, a node that transmits a packet to the routers based on one set address, and transmission paths that connect between the routers, wherein
the virtual router is constructed of a plurality of routers that are connected within the same network and are set in a relationship of a master and a backup by using the VRRP, each router comprising: a plurality of interfaces each of which is provided with an identification address and is set to a master state or a backup state, and which transmits a packet via a physical port; at least one substitute port that is allocated as a substitute port that substitutes the plurality of interfaces and that is set such that theoretically mutually different substitute ports exist in the interfaces; a connecting unit which connects between substitute ports of the own router and the other router respectively; a state changeover unit which changes over the state of the interface from a backup state to a master state according to a trouble on the route; and a transfer unit which transfers the packet by using the substitute port when a trouble has occurred on the route, and the router transferring the packet via the substitute port according to a trouble on the route.

47. The system according to claim 46, wherein
the packet is provided with an identifier that specifies a virtual network, and
each router is further provided with an allocating unit which specifies the interface to which the virtual network belongs according to the identifier, and allocates the packet to the physical port of the specified interface.

48. A system for connecting between networks having a virtual router constructed of a plurality of routers connected within the same network and set in a relationship of a master and a backup using the VRRP, a node that transmits a packet to the routers based on one set address, and transmission paths that connect between the routers, wherein
the virtual router is constructed of a plurality of routers that are connected within the same network and are set in a relationship of a master and a backup by using the VRRP, each router comprising: a plurality of interfaces each of which is provided with an identification address and is set to a master state or a backup state, and which transmits a packet via a physical port; at least two physical ports that are normally used as ports of the interfaces, that are allocated as a physical port and a substitute port normally used in at least two interfaces, and that are set such that theoretically mutually different physical ports and substitute ports exist in the interfaces; a state changeover unit which changes over the state of the interface from a backup state to a master state according to a trouble on the route; and a transfer unit which transfers the packet by using the substitute port when a trouble has occurred on the route, and the router transferring the packet via the substitute port according to a trouble on the route.

49. The system according to claim 48, wherein
the packet is provided with an identifier that specifies a virtual network, and
each router is further provided with an allocating unit which specifies the interface to which the virtual network belongs according to the identifier, and allocates the packet to the physical port of the specified interface.
